(19) United States
(12) Patent Application Publication
(10) Pub. No.: US 2019/0272732 A1
(43) Pub. Date: Sep. 5, 2019

(54) SEARCH SYSTEM AND TRANSMITTER FOR USE IN SEARCH SYSTEM

(71) Applicant: NIDEC CORPORATION, Kyoto (JP)

(72) Inventors: Junji ITO, Kyoto (JP); Huashi LIU, Kyoto (JP)

(73) Assignee: Nidec Corporation, Kyoto (JP)

(21) Appl. No.: 16/320,548

(22) PCT Filed: Jul. 25, 2017
(86) PCT No.: PCT/JP2017/026845

§ 371 Date: Jan. 25, 2019

(30) Foreign Application Priority Data
Jul. 29, 2016 (JP) 2016-149908

(51) Int. Cl. G08B 25/00; G01S 5/04; G08B 25/04; G01S 19/06; B64C 39/02

(52) U.S. Cl. CPC G08B 25/009; G01S 5/04; G08B 25/04; B64C 2201/146; B64C 39/024; B64C 2201/145; G01S 19/06

(57) ABSTRACT

A vehicle includes an antenna device to receive a wireless signal, a measuring device to measure a direction of arrival of the wireless signal received by the antenna device, a calculation circuit to estimate a position of the transmitter from the direction of arrival of the wireless signal as measured by the measuring device, and a localization device to output position information by estimating the vehicle's own position. The localization device outputs the position information of the vehicle at least when the calculation circuit has estimated the position of the transmitter.

### BACKGROUND OF THE INVENTION

### 1. Field of the Invention

The present disclosure relates to a search system, and a transmitter to be used in the search system.

### 2. Description of the Related Art

Japanese Patent No. 5890942 discloses a search target discovering unit which receives an electrical signal that is emitted from a signal generation device mounted on a target of search, and estimates the position of the target of search. The search target discovering unit includes a GPS device. Having received an electrical signal that is emitted from the signal generation device, the search target discovering unit transmits information of its own position, which was acquired by utilizing the GPS device, to another search target discovering unit or a position measurement device. The position measurement device receives a plurality of pieces of position information that are transmitted from the search target discovering unit(s), and performs three-point measurement to analyze the position at which the target of search exists.

By installing the search target discovering unit in a vehicle such as an automobile or an aircraft, and having a mountain climber or the like carry the signal generation device, if the mountain climber happens to be in distress, the presence of the person in distress can be known by using the search target discovering unit.

According to Japanese Patent No. 5890942, in order to perform three-point measurement, at least three search target discovering units must be placed on three vehicles.

### SUMMARY OF THE INVENTION

One non-limiting and exemplary embodiment of the present application provides a search system that detects with at least one vehicle a wireless signal that is output from a transmitter, and searches for the transmitter; and a transmitter to be used in the search system.

In an exemplary embodiment of the present disclosure, a search system detects with at least one vehicle a wireless signal that is output from a transmitter and searches for the transmitter, the vehicle including an antenna device to receive the wireless signal; a measuring device to measure a direction of arrival of the wireless signal received by the antenna device; a calculation circuit to estimate a position of the transmitter from the direction of arrival of the wireless signal as measured by the measuring device; and a localization device to output position information by estimating the vehicle's own position, wherein the localization device outputs the position information of the vehicle at least when the calculation circuit has estimated the position of the transmitter.

In another exemplary embodiment of the present disclosure, a search system detects with at least one vehicle a wireless signal that is output from a transmitter and searches for the transmitter, the search system including the vehicle, the transmitter, and the processing device, the vehicle including an antenna device to receive the wireless signal; a localization device to output position information by estimating the vehicle's own position; and a communication circuit to transmit a processed signal which is obtained from the wireless signal that is received by the antenna device and transmit the position information, the processing device including a communication circuit to receive the processed signal and the position information; and a calculation circuit to measure a direction of arrival of the wireless signal based on the processed signal, and further estimate a position of the transmitter from the direction of arrival of the wireless signal and the position information.

In an exemplary embodiment of the present disclosure, a transmitter is to be used in any of the above search systems, and includes a primary battery; an IC circuit to operate on the primary battery to generate the wireless signal; and an antenna element to output the wireless signal.

According to an exemplary embodiment of the present disclosure, at least one vehicle which has received a wireless signal that has been transmitted from a transmitter is able to measure the direction of arrival of the wireless signal. The vehicle estimates its own position and outputs position information. This allows the position of the transmitter to be estimated.

According to another exemplary embodiment of the present disclosure, at least one vehicle receives a wireless signal that has been transmitted from a transmitter, and transmits a processed signal which is obtained from the wireless signal to a processing device. The processing device measures the direction of arrival of the wireless signal, and is able to estimate the position of the transmitter.

Since the position of the transmitter is able to be estimated with at least one vehicle, the cost for introducing a search system is reduced as compared to the case where always three or more vehicles are needed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram showing the construction of a search system 100.

FIG. 2 is an outer perspective view of an exemplary multicopter 1 according to an exemplary embodiment of the present disclosure.

FIG. 3 is a side view of the multicopter 1.

FIG. 4 is a diagram showing schematically showing a hardware construction for the multicopter 1.

FIG. 5 is a diagram mainly showing an internal hardware construction for a flight controller 11.

FIG. 6A is a diagram showing the relationship between an antenna device 15 having M antenna elements constituting a linear array and a plurality of arriving waves k (k: an integer from 1 to K; the same also applies below; the meaning of K will be described later).

FIG. 6B is a diagram showing the antenna device 15 receiving a kth arriving wave.

FIG. 7 is a diagram showing a geometric relationship for measuring the direction of arrival of a wireless signal as performed by a calculation circuit 10.

FIG. 8 is a diagram showing a hardware construction for the processing device 40.

FIG. 9 is a diagram showing an internal construction of a transmitter 50.

FIG. 10 is a diagram showing how a magnesium-air battery 56 may be configured when not generating power.

FIG. 11 is a diagram showing a sealing lid 59 having slid.

FIG. 12 is an outer view of a life jacket 70 to be worn during activities at the sea or a river.

FIG. 13 is a diagram showing a procedure of a position estimation process for the transmitter 50 by the multicopter 1.

FIG. 14 is a diagram showing a procedure of processing by the multicopter 1 and the processing device 40 according to the second implementation.

FIG. 15 is a diagram showing a method of detecting a wireless signal that is transmitted from the transmitter 50 by using three multicopters 1a, 1b and 1c.

FIG. 16 is a diagram showing an exemplary operation where the multicopter 1a detects a wireless signal from the transmitter 50.

FIG. 17 is a diagram showing multicopters 1b and 1c which have flown near the multicopter 1a.

FIG. 18 is a diagram showing an exemplary flying method where the position of the transmitter 50 is estimated with a higher accuracy by using a single multicopter 1.

### DETAILED DESCRIPTION OF THE PREFERRED EMBODIMENTS

Hereinafter, with reference to the attached drawings, exemplary constructions of a search system according to the present disclosure and a transmitter to be used in the search system will be described. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the inventors so that those skilled in the art can sufficiently understand the present disclosure, are not intended to limit the scope of claims. In the present specification, identical or similar constituent elements are denoted by identical reference numerals.

1. Construction and Outline of Search System

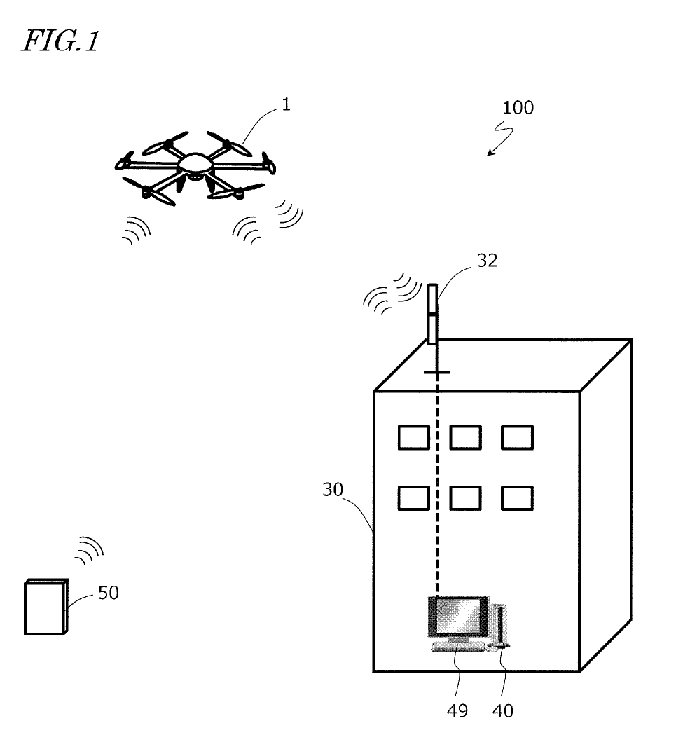

First, with reference to FIG. 1, a process to be performed by using a search system according to the present disclosure, which includes a vehicle, will be described in outline. The vehicle is typically an aircraft such as a multicopter, irrespective of whether it is unmanned or manned. A multicopter will be described as an example below.

FIG. 1 shows the construction of a search system 100. The search system 100 includes a multicopter 1, a position estimation processing device 40 within a search and rescue center facility 30, and a transmitter 50. Hereinafter, the position estimation processing device 40 will be abbreviated as “the processing device 40”.

In the search system 100 according to the present disclosure, generally two implementations are possible in use: a first implementation in which a process of estimating the position of the transmitter 50 is performed by the multicopter 1; and a second implementation in which a process of estimating the position of the transmitter 50 is performed by the externally-provided processing device 40. Specifics of the two implementations are as follows.

In the first implementation, the multicopter 1 uses an antenna device to detect a wireless signal which is output from the transmitter 50, and measures the direction of arrival of the wireless signal by using a measuring device which is mounted in the multicopter 1. Furthermore, a calculation circuit in the multicopter 1 performs a process of searching for the transmitter 50 from the direction of arrival of the wireless signal. Once the position of the transmitter 50 is estimated, together with information of the position of the transmitter 50, the multicopter 1 transmits position information which is obtained by estimating its own position by using the Global Positioning System (hereinafter referred to as “GPS”) or the like, to the processing device 40 in the search and rescue center facility 30. Note that two or more multicopters 1 may be used.

In the second implementation, the multicopter 1 detects a wireless signal which is output from the transmitter 50, and transmits it to the externally-provided processing device 40 as a processed signal which has undergone a predetermined process. At this time, the multicopter 1 also transmits to the processing device 40 position information which is obtained by estimating its own position by using a GPS unit or the like. By using the processed signal obtained from the multicopter 1, the processing device 40 measures the direction of arrival of the wireless signal, and performs a process of searching for the transmitter 50 from the measured direction of arrival and the position information of the multicopter 1.

In either implementation, an antenna device having a plurality of antenna elements which are arranged in an array is mounted on at least one multicopter 1, and a wireless signal that is transmitted from the transmitter is received with the antenna device. Then, at the multicopter 1, or at the processing device 40, the direction of arrival of the wireless signal is measured. Since presence of a plurality of multicopters 1 is not a requirement, the cost for introducing the search system 100 is reduced relative to the case where three or more multicopters 1 are always required as in Japanese Patent No. 5890942.

Moreover, the present disclosure describes a transmitter 50 that is suitably used in the search system 100 of either implementation.

For example, when the signal generation device described in Japanese Patent No. 5890942 is to be carried by a person, usually the signal generation device needs to be powered at all times in order to cope with an inadvertent fall, an avalanche, etc. As a result, it may be possible that, when in distress, the remaining power of the battery of the signal generation device may already have lowered, thereby hindering the rescue activity. Also, in a situation where electrical signals are being transmitted from all signal generation devices all the time, an electrical signal that is emitted from the signal generation device of a person in distress needs to be identified from among a multitude of electrical signals.

Therefore, in the present disclosure, a transmitter 50 will be illustrated which will begin emission of a wireless signal only in distress, for example. The transmitter 50 includes a magnesium-air battery which begins power generation when a liquid containing an electrolyte is injected therein. In a distress incident in the mountains, a bearer of the transmitter 50 may inject the water that he or she carries, or water which is obtained from a stream or snow, into the battery. Alternatively, in the case of drowning at the sea or in a river, a bearer of the transmitter 50 who has attached the transmitter 50 onto his or her life vest may automatically allow water from the sea or the river to be injected into the battery.

For example, upon detecting that emission of a wireless signal has begun as electric power is supplied to the processing device 40 being installed in the search and rescue center facility 30 transmitter 50, an audio, a screen indication, or a lamp is activated indicating that a search-requiring situation (e.g., a disaster or a distress situation) has occurred, and is notified to the operator of the system 100. As mentioned above, in either the first implementation or the second implementation, the position of the transmitter 50 has been estimated by the search system 100. As a result of this, the system operator is able to swiftly commence rescue activities, such as organizing and dispatching a search team. The battery of the transmitter 50 possesses sufficient electric power because it has never been used prior to the occurrence of the search-requiring situation, and thus is able to stably continue operation during the rescue activity.

Next, the multicopter 1, the processing device 40, and the transmitter 50 will be described in detail. The following description will illustrate a construction which is adapted to the aforementioned first implementation.

2. Construction of Multicopter

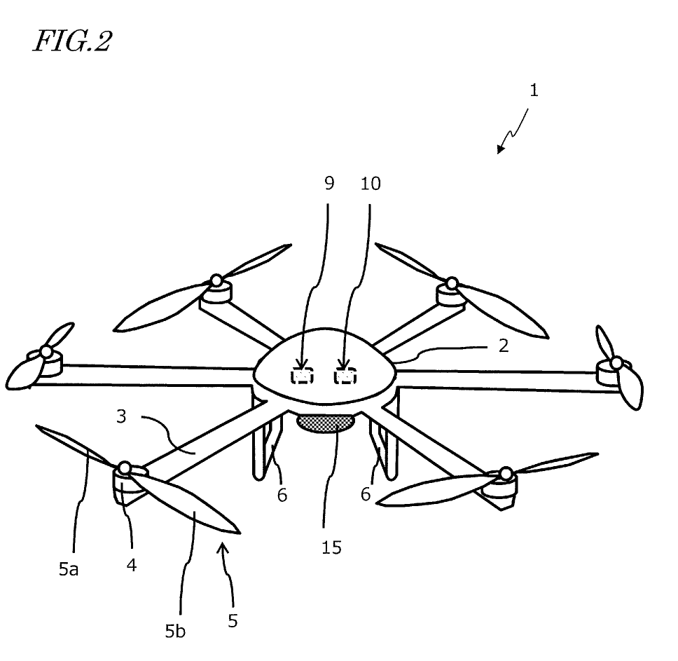

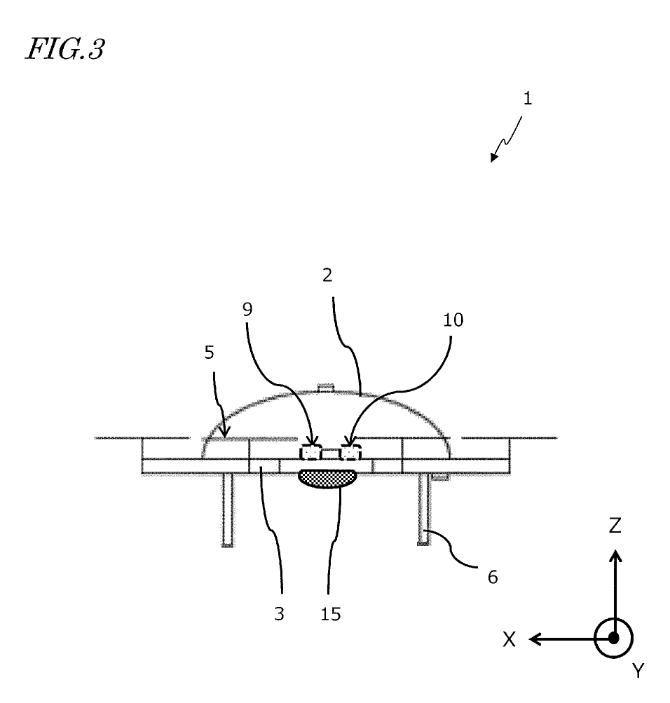

FIG. 2 is an outer perspective view of an exemplary multicopter 1 according to the present disclosure. FIG. 3 is a side view of the multicopter 1.

The multicopter 1 flies in the sky over e.g. a mountain range, the sea, or a river, and detects a wireless signal which is output from the transmitter 50. By utilizing the GPS, the multicopter 1 autonomously flies in a predetermined airspace. As will be described later, upon detecting a wireless signal that is transmitted from the transmitter 50, the multicopter 1 operates in a search mode to search for the position of the transmitter 50.

The multicopter 1 includes a central housing 2, a plurality of arms (as exemplified by an arm 3) extending out from the periphery of the central housing 2, and a plurality of legs 6 extending below the central housing 2. Hereinafter, an exemplary construction related to the arm 3 will be described; anything that applies to the construction of this arm 3 similarly applies to any other arm.

At the tip end of the arm 3 (i.e., the opposite end from the central housing 2), a motor 4 is provided. A rotor 5 is provided on the axis of rotation of the motor 4. As the motor 4 rotates, the rotor 5 also rotates, thus giving lift for the multicopter 1. In the present specification, the number of rotors 5 provided on a single multicopter 1 may be arbitrary so long as the flight as will be described below is possible.

Each rotor 5 that is attached to a motor 4 includes a plurality of blades 5a and 5b that extend from its axis of rotation. However, there may be three or more blades. From standpoints such as strength, weight, etc., the rotors 5 are preferably made of carbon-fiber-reinforced plastic (CFRP).

The multicopter 1 includes an antenna device 15 to receive a wireless signal from the transmitter 50, a measuring device 9 to measure the direction of arrival of the wireless signal received by the antenna device 15, and a calculation circuit 10 to estimate the position of the transmitter 50 from the direction of arrival of the wireless signal having been measured by the measuring device 9. Details of the processing by the measuring device 9 and the calculation circuit 10 will be described later.

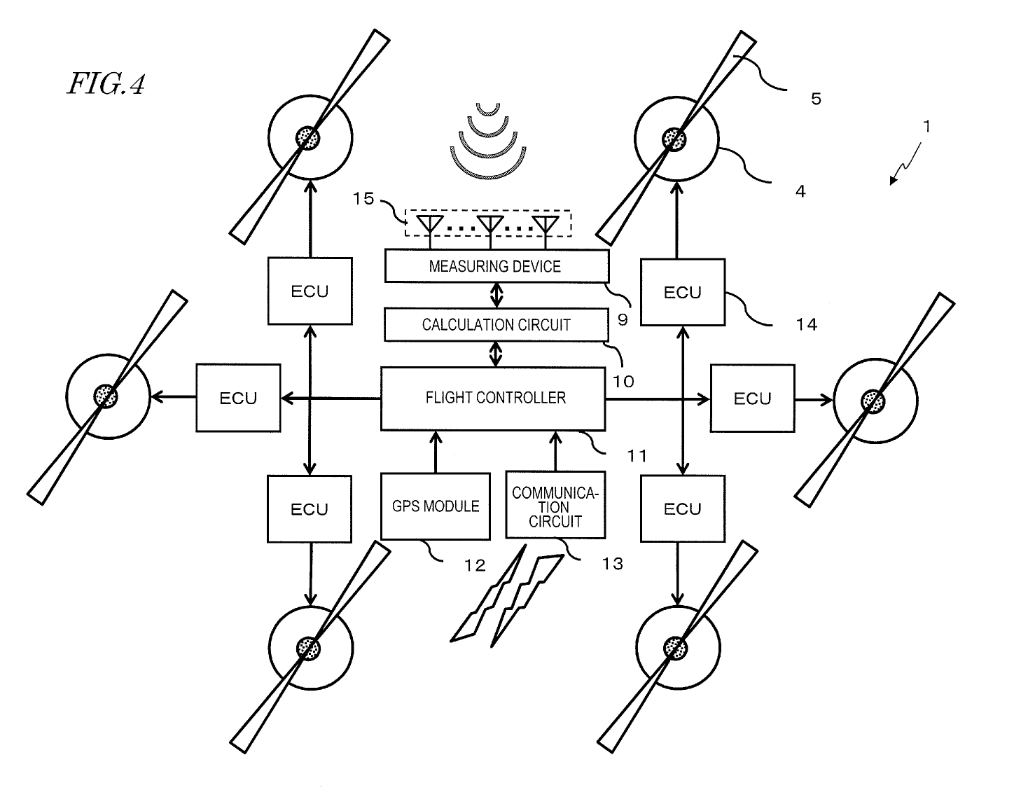

FIG. 4 schematically shows a hardware construction for the multicopter 1.

The multicopter 1 includes the measuring device 9, the calculation circuit 10, a flight controller 11, a GPS module 12, a communication circuit 13, electronic control units 14 (ECUs 14) and an antenna device 15. Among these, the flight controller 11 controls the operation of the multicopter 1.

The flight controller 11 receives information and/or manipulation signals from the radar system 10, the GPS module 12, and the reception module 13, subjects them to predetermined processing in order to conduct flight, and outputs a control signal to each ECU 14. Moreover, upon receiving a wireless signal that is transmitted from the transmitter 50 via the antenna device 15, the flight controller 11 causes the measuring device 9 to measure the direction of arrival of the wireless signal. Furthermore, the flight controller 11 causes the calculation circuit 10 to estimate the position of the transmitter 50 from the direction of arrival of the wireless signal as measured by the measuring device 9. However, the measuring device 9 and the calculation circuit 10 may not be controlled by the flight controller 11. For example, when a predetermined input is made from the antenna device 15, the measuring device 9 may perform a predetermined process of measuring the direction of arrival of the wireless signal. Moreover, upon receiving information indicating the direction of arrival of the wireless signal from the measuring device, the calculation circuit 10 may perform a predetermined operation of estimating the position of the transmitter 50.

Each ECU 14 controls rotation of the motor 4 based on the control signal. By controlling rotation of all of the motors 4, the flight controller 11 can cause the multicopter 1 to move forward, move backward, circle, stay still in the air, or move up or down. In causing the multicopter 1 to move forward or move backward, the attitude of the multicopter 1 may be controlled so that it is leaning forward or leaning backward. As an implementation of rotational control for the motor 4, PMW (Pulse Width Modulation) may be utilized, for example. In this case, each ECU 14 controls the power to be supplied to the motor 4 by altering the PWM duty ratio.

Instead of the motor 4, an engine which burns a liquid fuel to rotate may be adopted.

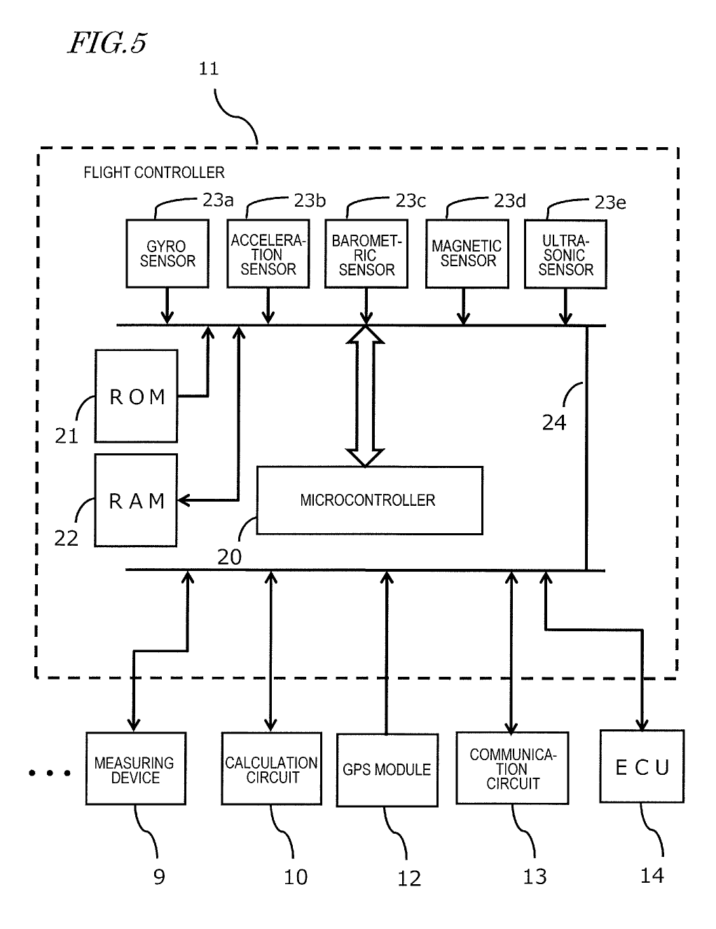

FIG. 5 mainly shows an internal hardware construction of the flight controller 11.

The flight controller 11 includes a microcontroller 20, a ROM 21, a RAM 22, and a sensor group, which are interconnected via an internal bus 24 so as to be capable of communicating with one another. Via a communication interface not shown, the flight controller 11 is connected to the GPS module 12, the communication circuit 13, and the plurality of ECUs 14. A data signal which is input via the communication interface is transmitted inside the flight controller 11 via the internal bus 24, and acquired by the microcontroller 20. Hereinafter, this will be described more specifically. Note that processing by the microcontroller 20 is realized as a computer program which is stored in the ROM 21 and laid out on the RAM 22 is executed by the microcontroller 20.

The microcontroller 20 acquires signals that have been detected by the sensor group. The sensor group may include, for example, a three-axis gyro sensor 23a, a three-axis acceleration sensor 23b, a barometric sensor 23c, a magnetic sensor 23d, an ultrasonic sensor 23e, and so on.

The three-axis gyro sensor 23a detects a forward-backward inclination, a right-left inclination, and an angular rate of rotation, thus grasping the attitude and motion of the multicopter body. The three-axis acceleration sensor 23b detects acceleration along the front-rear direction, the right-left direction, and the up-down direction. Note that the three-axis gyro sensor and the three-axis acceleration sensor may be implemented by a single module. Such a module may be referred to as a “six-axis gyro sensor”. The barometric sensor 23c grasps the altitude of the multicopter body based on differences in barometric pressure. The magnetic sensor 23d detects azimuth. The ultrasonic sensor 23e emits an ultrasonic wave immediately below and detects a reflection signal to grasp the distance from the ground. Note that the ultrasonic sensor 23e is to be used at a predetermined altitude not far from the ground.

Furthermore, the microcontroller 20 acquires information of the current position of the multicopter 1 from the GPS module 12. The “current position” includes information of a latitude, a longitude, and an altitude around the globe. The GPS module 12 receives radio waves from a plurality of artificial satellites (GPS satellites) and computes a distance between itself and each GPS satellite, so as to output information indicating the current position. By utilizing at least four artificial satellites, the GPS module 12 is able to output information indicating the latitude, longitude, and altitude of the multicopter 1 anywhere around the globe.

The microcontroller 20 acquires a manipulation signal from the communication circuit 13. The manipulation signal is transmitted from the search and rescue center facility 30 via an antenna device 32, for example. For example, the manipulation signal is a signal instructing the multicopter 1 to begin flight or return. In the present specification, the airspace for the multicopter 1 to fly is predefined, and the multicopter 1 autonomously flies in the airspace upon receiving an instruction to begin flight. When receiving a manipulation signal designating a return, or when the remaining power of the battery (not shown) becomes equal to a predetermined level or lower, the multicopter 1 returns to the search and rescue center facility 30.

Based on signals which are acquired from the sensor group, or on an externally acquired signal, the microcontroller 20 outputs appropriate control signals to the ECUs 14. Upon receiving the control signal, each ECU 14 drives the motor 4. Specifically, each ECU 14 alters the rotational speed of the motor 4, or the control signal which it outputs to rotate the motor 4.

Note that the GPS module 12 is an example for acquiring information of the current position of the multicopter 1. As another example of acquiring information of the current position of the multicopter 1, when the communication circuit 13 supports radio waves of a mobile phone frequency, for example, the radio wave intensities from a plurality of base stations for the mobile phone, etc., may be utilized to acquire information of the current position. Also, accurate position information when beginning flight may be acquired, and information of the current position during flight may be acquired by further utilizing the aforementioned gyro sensor 23a, the three-axis acceleration sensor 23b, the barometric sensor 23c, the magnetic sensor 23d, and the ultrasonic sensor 23e during flight. In the present specification, any device including the GPS module 12 and the various aforementioned sensors that is capable of acquiring position information will be collectively referred to as a “localization device”.

Moreover, based on the position information that is acquired by using the “localization device”, the flight controller controls rotation of each of the plurality of motors 4 or engines. As a result, the flight controller 11 is able to control autonomous flight in a predetermined airspace or in an airspace that is designated by the processing device 40. As such, the flight controller 11 may be referred to as an “autonomous flight unit”.

Next, the antenna device 15 and the measuring device 9 will be described. For example, the antenna device 15 is an array antenna in a two-dimensional (planar) arrangement, and the measuring device 9 is a microcomputer which performs the following process. Although the process performed by the measuring device is a process of “estimating” the direction of arrival of a wireless signal, this process will be described as “measuring” in the present specification.

For simplicity of description, one row of antenna elements constituting a linear array within an array antenna in a two-dimensional arrangement will be discussed, and a technique of estimating the direction of arrival of a signal wave impinging on this one of antenna elements will be described.

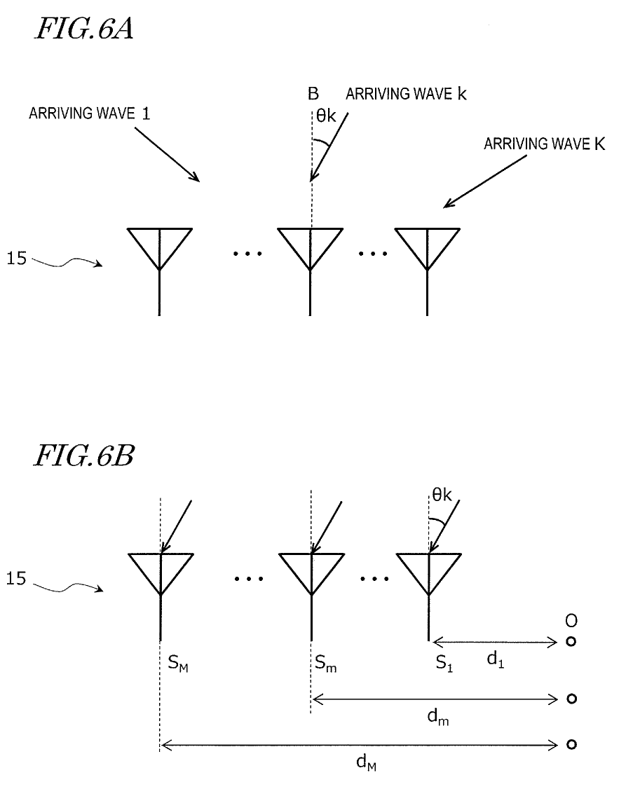

FIG. 6A shows a relationship between an antenna device 15 having M antenna elements constituting a linear array and a plurality of arriving waves k (k: an integer from 1 to K; the same also applies below; the meaning of K will be described later). Each arriving wave is a wireless signal. Although the wireless signals are conveniently illustrated as coming from above in the figure, the wireless signals are being transmitted from a transmitter 50 which is on the ground surface or water in the example of the present embodiment.

The antenna device 15 receives plural arriving waves that simultaneously impinge at various angles. The incident angle of each arriving wave (i.e., an angle representing its direction of arrival) is an angle with respect to the broadside B (i.e., a direction which is perpendicular to the direction of the line along which the antenna elements are arrayed) of the antenna device 15.

Now, consider a k^{th} arriving wave. Where K arriving waves are impinging on the array antenna from K targets existing at different azimuths, a “k^{th} arriving wave” means an arriving wave which is identified by an incident angle θₖ.

FIG. 6B shows the antenna device 15 receiving the k^{th} arriving wave. The signals received by the antenna device 15 can be expressed as a “vector” having M elements, by Math. 1.

S=[s₁,s₂, . . . ,s_{M}]^{T} (Math. 1)

In the above, sₘ (where m is an integer from 1 to M; the same will also be true hereinbelow) is the value of a signal which is received by an m^{th} antenna element. The superscript ^{T} means transposition. S is a column vector. The column vector S is defined by a product of multiplication between a direction vector (a steering vector or a mode vector) as determined by the construction of the array antenna and a complex vector representing a signal from each wave source (signal source). When the number of wave sources is K, the waves of signals arriving at each individual antenna element from the respective K wave sources are linearly superposed. In this state, sₘ is known to be expressible by Math. 2.

$${s}_{m} = {\sum }_{k = 1}^{K} {a}_{k} exp \{ j ( \frac{2 π}{λ} {d}_{m} sin {θ}_{k} + {ϕ}_{k} ) \} \qquad [ Math . 2 ]$$

In Math. 2, aₖ, θₖ and ϕₖ respectively denote the amplitude, incident angle (i.e., an angle representing the direction of arrival), and initial phase of the k^{th} arriving wave. Moreover, A denotes the wavelength of an arriving wave, and j is an imaginary unit.

As will be understood from Math. 2, sₘ is expressed as a complex number consisting of a real part (Re) and an imaginary part (Im).

When this is further generalized by taking noise (internal noise or thermal noise) into consideration, the array reception signal X can be expressed as Math. 3.

X=S+N (Math. 3)

N is a vector expression of noise.

The measuring device 9 generates a spatial covariance matrix Rxx (Math. 4) of arriving waves by using the array reception signal X expressed by Math. 3, and further determines eigenvalues of the spatial covariance matrix Rxx.

$$\begin{matrix}{R}_{xx} = {XX}^{H} \\ = [ \begin{matrix}{Rxx}_{11} & … & {Rxx}_{1 M} \\ ⋮ & ⋱ & ⋮ \\ {Rxx}_{M 1} & … & {Rxx}_{MM}\end{matrix} ]\end{matrix} \qquad [ Math . 4 ]$$

In the above, the superscript ^{H} means complex conjugate transposition (Hermitian conjugate).

Among the eigenvalues, the number of eigenvalues which have values equal to or greater than a predetermined value that is defined based on thermal noise (signal space eigenvalues) corresponds to the number of arriving waves. Then, angles that produce the highest likelihood as to the directions of arrival of reflected waves (i.e. maximum likelihood) are calculated, whereby the number of targets and the angles at which the respective targets are present can be identified. This process is known as a maximum likelihood estimation technique.

Through the above process, the measuring device 9 outputs an angle θ that takes the largest value as the azimuth at which the transmitter 50 exists. Note that the method of estimating the angle θ indicating the direction of arrival of an arriving wave is not limited to this example. Various algorithms for direction-of-arrival estimation that have been mentioned earlier can be employed. For example, with a maximum likelihood estimation technique such as the SAGE (Space-Alternating Generalized Expectation-maximization) method, azimuths of plural arriving waves with high correlation can be detected by utilizing information on the number of arriving waves. Since maximum likelihood estimation techniques such as SAGE are known techniques, detailed descriptions thereof are omitted. The azimuth of arrival of a radio wave may be estimated by using an amplitude monopulse method.

When one row of antenna elements constituting a linear array is used, the direction of arrival of a wireless signal can be estimated regarding the direction (first direction) along which wireless signals impinging on the row of antenna elements will have phase differences. However, regarding a second direction which is perpendicular to the first direction, the direction of arrival of a wireless signal cannot be estimated. In order to estimate a direction of arrival regarding the second direction, it is necessary to use antenna elements that are arranged in a two-dimensional (planar) array. Since techniques for calculating the first direction and the second direction by using antenna elements which are arranged in a two-dimensional array are well known, any detailed description thereof will be omitted in the present specification.

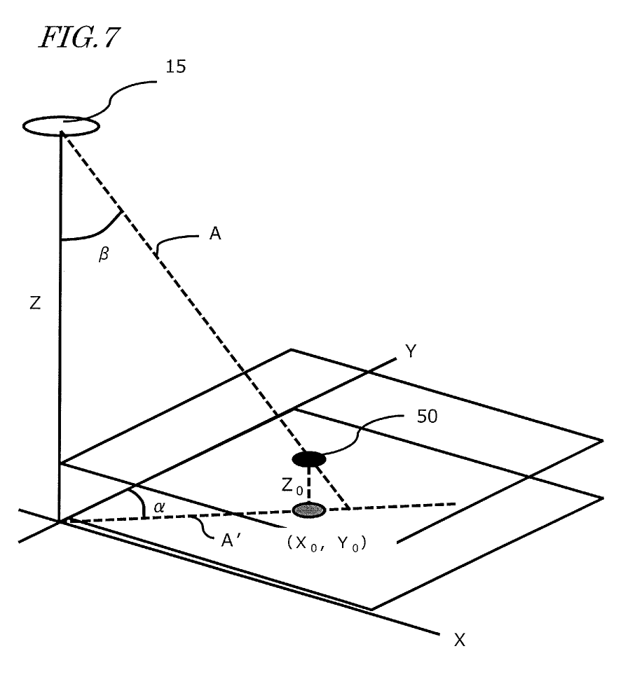

FIG. 7 shows a geometric relationship for measuring the direction of arrival of a wireless signal as performed by the calculation circuit 10. An X axis, a Y axis, and a Z axis are taken as shown in the figure. The XY plane is a ground surface or a water surface. The Z axis represents the height direction. FIG. 7 illustrates the transmitter 50 being at a higher position than the ground surface (e.g. the middle of a cliff). In the case where the transmitter 50 is situated on a water surface, the transmitter 50 will be located on the XY plane.

With the measuring device 9, the direction of arrival of a wireless signal that is transmitted from the transmitter 50 is measured. The direction of arrival consists of an angle α in an azimuth direction and an angle β in an elevation direction. The angle α in an azimuth direction is an angle that is created by: a line A′, which is a projection on the XY plane of a line A that connects the antenna device 15 and the transmitter 50; and the Y axis. The angle β in an elevation direction is an angle that is created by the line A and the Z axis. By using the angles α and β and information of the current altitude of the multicopter 1, the calculation circuit 10 is able to estimate the position of the transmitter 50.

In the case where the transmitter 50 is situated on a water surface, for example, the calculation circuit 10 estimates the transmitter 50 to be present at the position of an intersection between the line A and the water surface. If the multicopter 1 retains information of a topographic map, the calculation circuit 10 may refer to the information of the topographic map in order to recognize whether or not the transmitter 50 is situated on a water surface. Alternatively, the calculation circuit 10 may recognize whether or not the transmitter 50 is situated on a water surface on the basis of a notification from the processing device 40.

In the case where the transmitter 50 is situated on land, such that the multicopter 1 retains information of a topographic map, for example, the calculation circuit 10 may refer to the information of the topographic map to determine that a topographical feature such as a cliff exists at the intersection between the line A and the ground surface. In that case, the calculation circuit 10 estimates the transmitter 50 to be present at the position (X₀,Y₀,Z₀) of the intersection between the line A and the cliff.

Through the above process, the multicopter 1 is able to estimate the position of the transmitter 50.

Note that Quuppa Oy in Finland provides a locating system utilizing the position estimation technique. In the present embodiment, this locating system can be utilized.

3. Construction of Position Estimation Processing Device

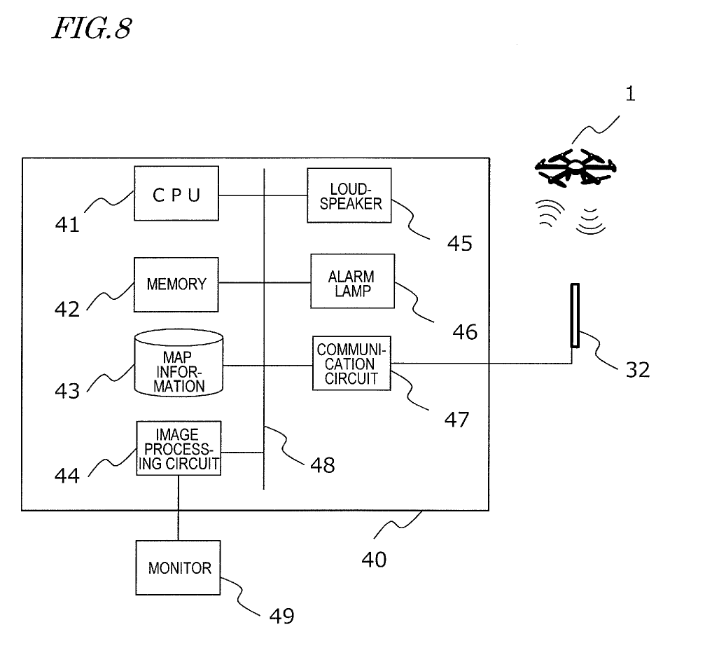

FIG. 8 shows a hardware construction for the processing device 40.

The processing device 40 includes a central processing unit (CPU) 41, a memory 42, map information 43, an image processing circuit 44, a loudspeaker 45, an alarm lamp 46, and a communication circuit 47, which are connected via an internal bus 48. A monitor 49 is connected to the processing device 40. The processing device 40 is a typically computer system such as a PC. Alternatively, the processing device 40 may be a portable terminal such as a smartphone, a tablet computer, or a laptop computer.

Via the antenna device 32 of the search and rescue center facility 30, the communication circuits 47 receives a wireless signal representing an estimated position of the transmitter and position information from the multicopter 1, and transmit them to the CPU 41. In response to receiving such information, the CPU 41 notifies an operator of the search system 100 that a search-requiring situation (e.g., a disaster or a distress situation) has occurred.

For example, the CPU 41 may refer to the map information 43 by utilizing an estimated position of the transmitter and position information of the multicopter 1. The map information 43 contains a map of an expected area of search and data of a topographic map. The CPU 41 generates a premeditated message and a map image in which an estimated position of the transmitter 50 is identifiably indicated, causes the image processing circuit 44 to process these, and causes the monitor 49 to display them. Alternatively, the CPU 41 outputs audio data which was previously retained in the memory 42, from the loudspeaker 45. Alternatively, the CPU 41 causes the alarm lamp 46 to flicker in a flicker pattern which was previously retained in the memory 42. As a result of this, the operator is able to swiftly commence rescue activities, such as organizing and dispatching a search team. Note that it is not essential to provide the image processing circuit 44. Instead of the image processing circuit 44, the CPU 41 may perform the same process.

In the present specification, a device which outputs a visual, aural, or tactile stimulation for invoking human attention may be referred to as an “output device”. The monitor 49, the loudspeaker 45, and the alarm lamp 46 are encompassed within an output device. Moreover, a motor which outputs a tactile stimulation through vibration is also encompassed within an output device.

4. Construction of Transmitter

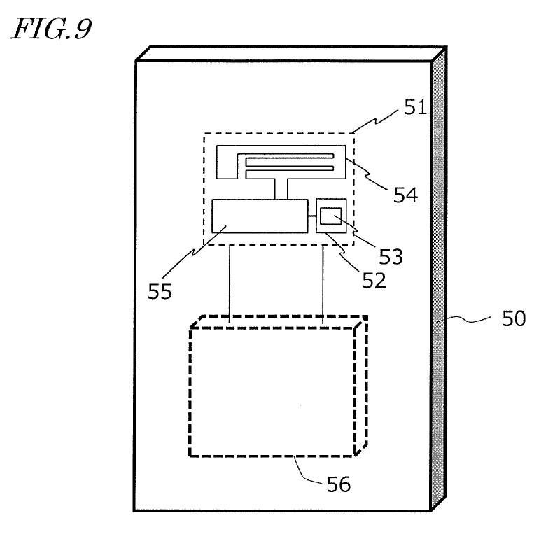

FIG. 9 shows an internal construction of the transmitter 50. The transmitter 50 includes a wireless circuit 51 and a magnesium-air battery 56. The wireless circuit 51 includes a storage device 52, an antenna element 54, and an IC circuit 55. The storage device 52, which may be e.g. a flash ROM, stores a unique piece of identification information 53 for each transmitter 50. Once electric power is supplied from the magnesium-air battery 56, the IC circuit 55 generates an RF signal of a predetermined frequency, and periodically transmits it via the antenna element 54.

The magnesium-air battery 56 is a primary battery, and begins power generation as a liquid containing an electrolyte such as water is injected therein. Until a liquid is injected, the magnesium-air battery 56 can be preserved for a long period of time, e.g., ten or more years, without deterioration. The bearer may manually inject a liquid when desiring to be searched for.

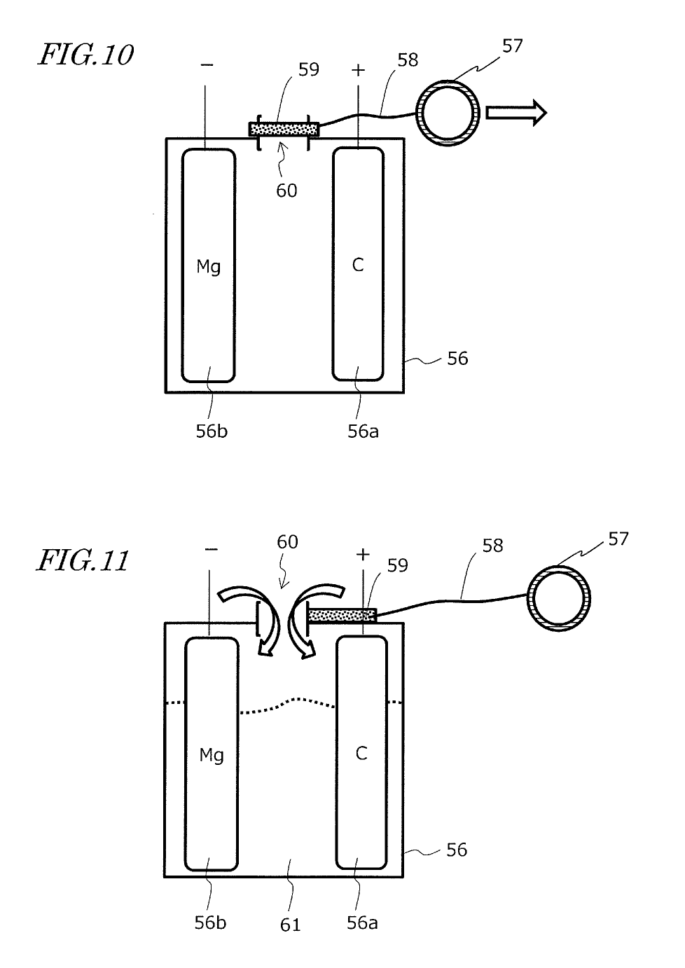

FIG. 10 shows how the magnesium-air battery 56 may be configured when not generating power. The magnesium-air battery 56 includes a positive electrode 56a which is composed of carbon and a negative electrode 56b which is composed of magnesium. The magnesium-air battery 56 has a ring 57, a sealing lid 59, and a cord 58 that connects the ring 57 and the sealing lid 59.

The sealing lid 59 closes a liquid inlet 60. As the bearer pulls the ring 57, the sealing lid 59 slides. FIG. 11 shows the sealing lid 59 having slid. As a result of this, the bearer is able to inject a liquid through the liquid inlet 60. FIG. 11 shows the liquid 61 having been injected.

Since very little electric power is required for the generation and transmission of a wireless signal, even if the transmitter 50 has an approximate size of a business card, the magnesium-air battery 56 is able to generate electric power for transmitting wireless signals for about one week. The transmitter 50 transmits a wireless signal having a frequency of 2.4 GHz that is compliant with Bluetooth (registered trademark) 4.0 (also called “BLE”), which is a short-range wireless communication standard of low power consumption. In the outdoors with clear view, with no other wireless equipment around, a wireless signal can travel about 300 m to about 1 km. The antenna device 15 of the multicopter 1 also receives a wireless signal of specifications that are compliant with the same standard as the communication standard of the transmitter 50.

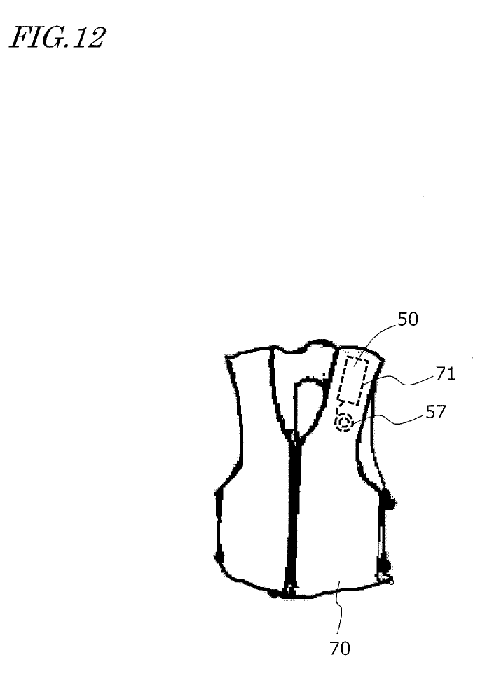

FIG. 12 is an outer view of a life jacket 70 to be worn during activities at the sea or a river. The life jacket 70 has a pocket 71, where the transmitter 50 can be attached. In case of a fall at the sea or a river, the person who has fallen may pull on the ring 57, thus allowing water in the surroundings to be injected into the magnesium-air battery 56, which will then begin power generation. Thereafter, wireless signal transmission will be continuously performed. Since the magnesium-air battery 56 of the transmitter 50 has never been used prior to the occurrence of the search-requiring situation, it has sufficient electric power. Therefore, wireless signal transmission can be stably continued until position estimation by the multicopter 1 and until arrival of a rescue squad.

The position of the pocket 71 is preferably a position which allows water to be injected into the magnesium-air battery 56 while the person wearing it keeps drifting and which will be free from submersion so that wireless signal transmission will be enabled. The sealing lid 59 may be omitted so that a liquid will automatically go into the magnesium-air battery 56 when a fall into water occurs.

5. Position Estimation Process by Multicopter 1

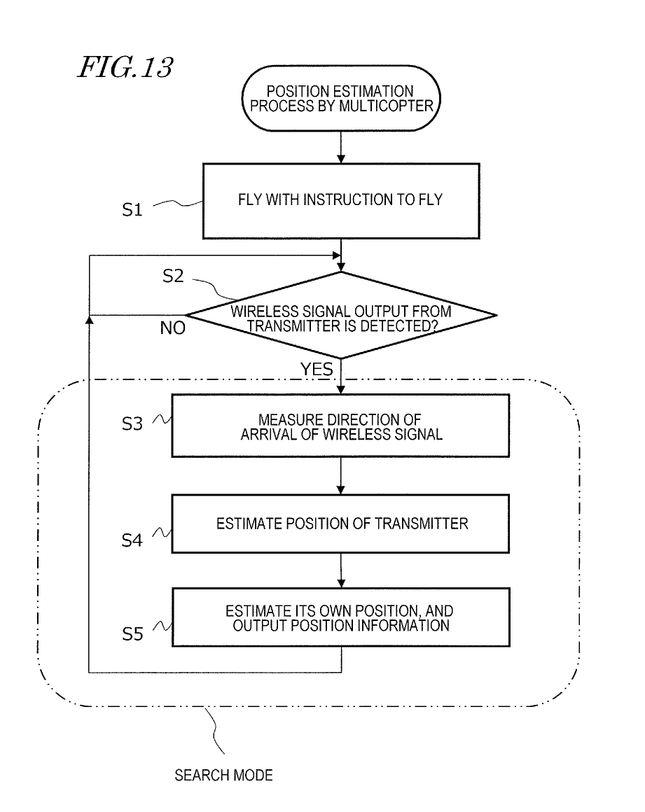

FIG. 13 shows a procedure of a position estimation process for the transmitter 50 by the multicopter 1.

At step S1, the flight controller 11 of the multicopter 1 flies in accordance with an instruction to fly from the processing device 40 in the search and rescue center facility 30. During flight, electric power is continuously supplied to the antenna device 15 so that wireless signals can be received.

At step S2, the measuring device 9 determines whether a wireless signal which has been output from the transmitter 50 was detected or not. The measuring device 9 repeats the determination of step S2 until a wireless signal which has been output from the transmitter 50 is detected. Upon detecting a wireless signal, the measuring device 9 executes the process of step S3. Note that steps S1 and 2 are a normal flight mode to be applied until a wireless signal is detected, whereas steps S3 to S5 are a search mode for searching for the transmitter 50 due to the fact that a wireless signal has been detected.

At step S3, the measuring device 9 measures the direction of arrival of the wireless signal. At the next step S4, the calculation circuit 10 utilizes information indicating the direction of arrival of the wireless signal to estimate the position of the transmitter 50. The process of measuring the direction of arrival of the wireless signal and estimating the position of the transmitter 50 is as has already been described.

At step S5, the flight controller 11 estimates the current position by utilizing the GPS module 12, for example, and outputs position information to the processing device 40 in the search and rescue center facility 30 via the communication circuit 13. At this time, the estimated position information of the transmitter 50 may also be transmitted together.

Through the above processing, discovery and rescue of the person to be rescued bearing the transmitter 50 can be achieved by using the multicopter 1.

6. Position Estimation Process by Processing Device

Next, an operation of the search system 100 operating according to the second implementation, which was explained at the beginning of the present embodiment, will be described. So far as the second implementation is concerned, the measuring device 9 and the calculation circuit 10 can be omitted from the multicopter 1.

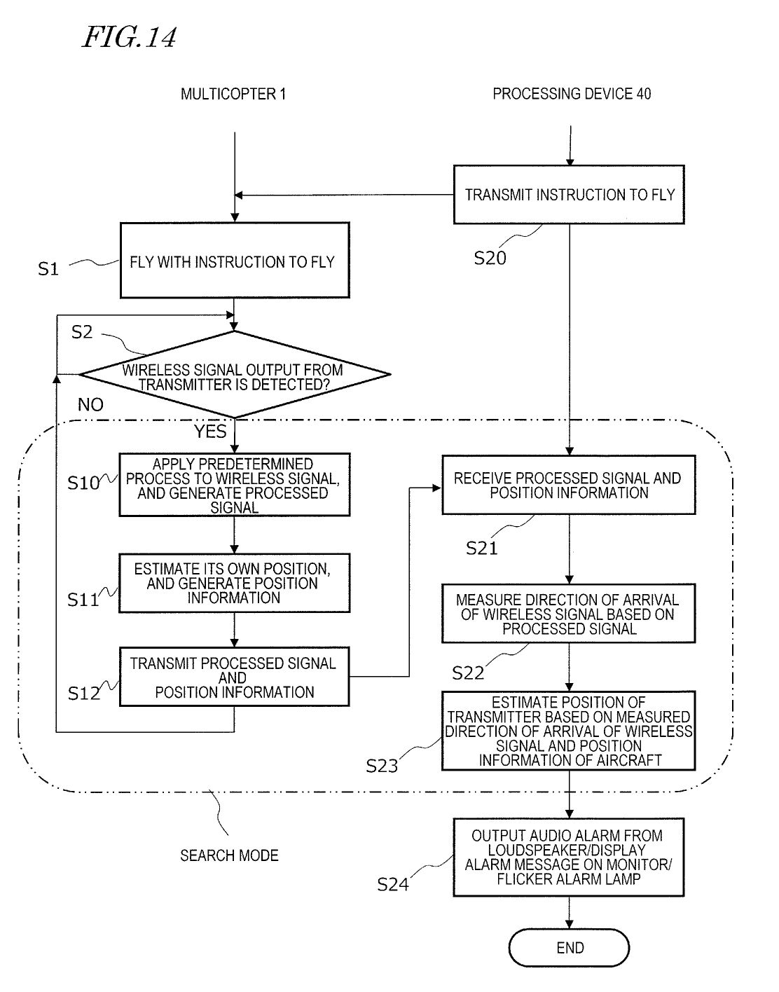

FIG. 14 shows a procedure of processing by the multicopter 1 and the processing device 40 according to the second implementation. First, at step S20, an instruction to fly is transmitted from the processing device 40 to the multicopter 1, via the antenna 32.

Thereafter, in the multicopter 1, the aforementioned processes of steps S1 and S2 are performed. After this, operations under the search mode are performed by the multicopter 1 and the processing device 40.

At step S10, the flight controller 11 of the multicopter 1 applies a predetermined process to a wireless signal to generate a processed signal. The “predetermined process” may be e.g. a filtering process for the wireless signal and a digitalization process. At step S11, the flight controller 11 estimates the current position by utilizing the GPS module 12, for example, and generates position information.

At step S12, the processed signal and position information having been generated are transmitted to the processing device 40 via the communication circuit 13.

Steps S21 to S24 are processes to be performed by the CPU 41 of the processing device 40.

At step S21, the CPU 41 receives the processed signal and position information via the communication circuit 47.

At step S22, based on the processed signal, the CPU 41 measures the direction of arrival of the wireless signal.

At step S23, based on the measured direction of arrival of the wireless signal and the position information of the multicopter 1, the CPU 41 estimates the position of the transmitter 50.

At step S24, the CPU 41 notifies the operator of the search system 100 that a search-requiring situation (e.g., a disaster or a distress situation) has occurred. Specifically, the CPU 41 causes the loudspeaker 45 to output an audio alarm, the monitor 49 to display an alarm message, and/or the alarm lamp 46 to flicker.

According to the processing of FIG. 14, the multicopter 1 may not include the measuring device 9 and the calculation circuit 10, so that the cost of the multicopter 1 can be reduced. Moreover, omission of the measuring device 9 and the calculation circuit 10 also reduces power consumption.

7. Flying Method of Multicopter

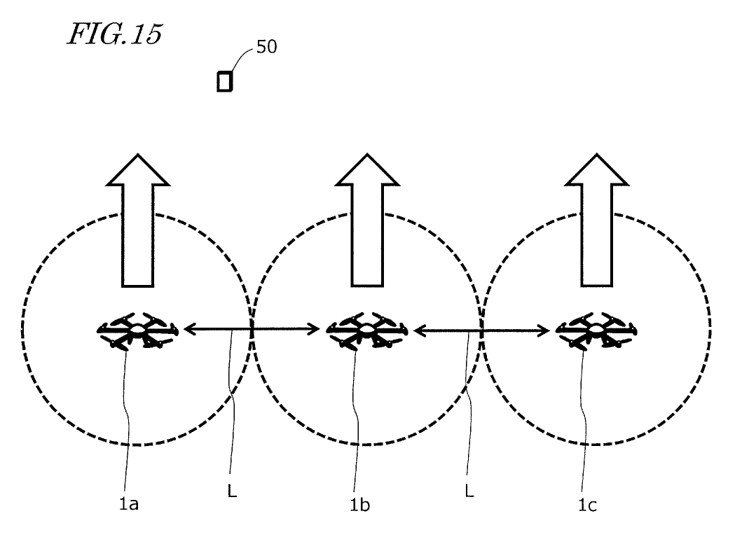

Next, with reference to FIGS. 15 through 18, variants concerning the flying method of the multicopter 1 will be described.

FIG. 15 shows a method of detecting a wireless signal that is transmitted from the transmitter 50 by using three multicopters 1a, 1b and 1c. Given that each multicopter 1a, 1b, 1c is able to detect a wireless signal in a range with a radius of about 100 m, the multicopters 1a, 1b and 1c may fly abreast at an interval L which is less than about 200 m. In other words, the interval L may be determined based on the range of detection capability of the multicopters. Note that it may be two multicopters 1, or four or more multicopters 1, that fly abreast.

FIG. 16 shows an exemplary operation where the multicopter 1a detects a wireless signal from the transmitter 50. To the other multicopters 1b and 1c, the multicopter 1a having detected the wireless signal transmits not only a notification that a wireless signal has been detected, but also position information that has been estimated by using the GPS module 12.

Having received the notification, the multicopters 1b and 1c head for the multicopter 1a, on the basis of the received position information of the multicopter 1a. The purpose of this is to estimate the position of the transmitter 50 rapidly and with a higher accuracy.

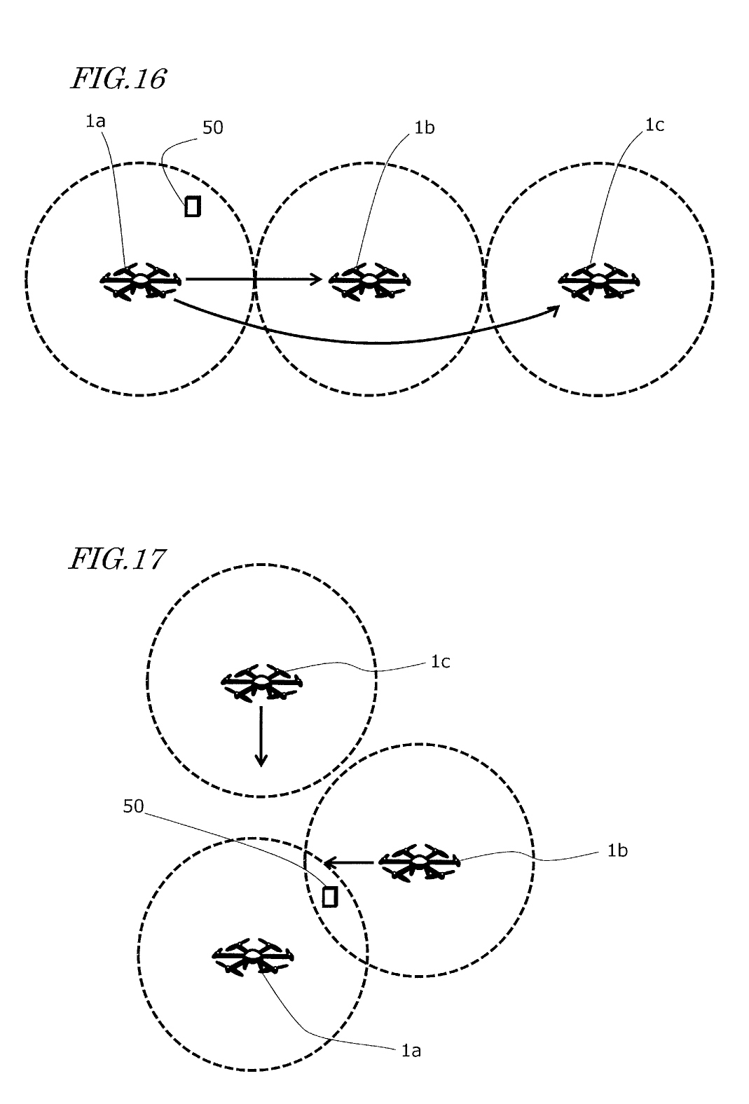

FIG. 17 shows the multicopters 1b and 1c having flown near the multicopter 1a. By flying near the multicopter 1a, the multicopters 1b and 1c will also receive the wireless signal from the transmitter 50. In this case, the multicopters 1a through 1c could estimate the position of the transmitter 50 via so-called three-point measurement. In other words, the transmitter 50 can be said to be present within a range where the ranges of detection capability of all of the multicopters 1a through 1c overlap.

Each of the multicopters 1a through 1c may estimate the position of the transmitter 50. If consequently the estimated positions by two or all of the multicopters 1a through 1c are identical, a very high likelihood exists that the transmitter 50 is present at that position. This allows the transmitter 50 to be rapidly found, even in a place with rises and falls, especially in the mountains, etc.

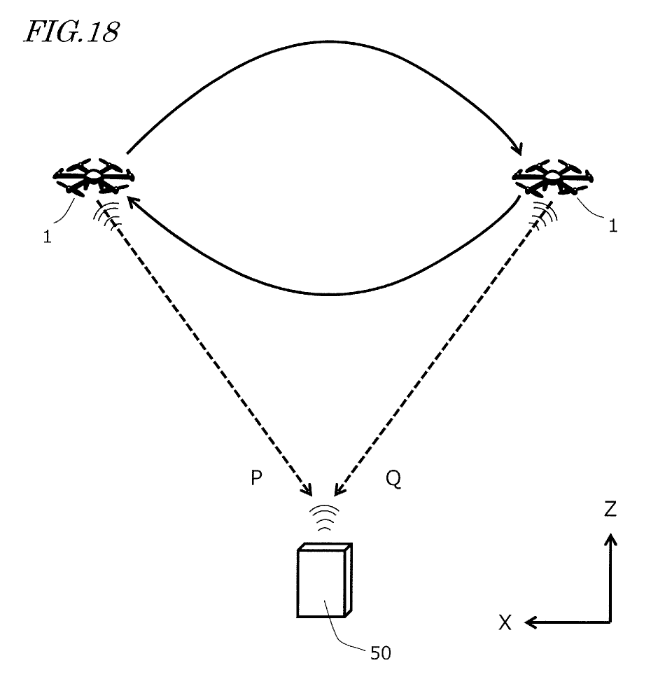

FIG. 18 shows an exemplary flying method where the position of the transmitter 50 is estimated with a higher accuracy by using a single multicopter 1.

When the antenna device 15 of the multicopter 1 receives a wireless signal from the transmitter 50, the flight controller 11 stops the multicopter 1 within the space in which the wireless signal was received. Since the antenna device 15 continuously receives the wireless signal, the calculation circuit 10 continuously estimates the position of the transmitter 50. Since a process of estimating the position of the transmitter 50 is performed a plurality of times at the same position, a higher accuracy of position estimation can be obtained.

Alternatively, the multicopter 1 may work so that, when the antenna device 15 of the multicopter 1 receives a wireless signal from the transmitter 50, the flight controller 11 causes the multicopter 1 to fly in circles within the space in which the wireless signal was received. Also while circling, the antenna device 15 continuously receives the wireless signal. Assume that the calculation circuit 10 estimates that the position of the transmitter 50 is in a direction P at one position of flight, and at another position of flight estimates that the position of the transmitter 50 is in a direction Q. Then, the flight controller 11 estimates an intersection between the estimated directions P and Q to be the position of the transmitter 50. This allows the multicopter 1 to estimate the position of the transmitter 50 with a higher accuracy.

### INDUSTRIAL APPLICABILITY

The search system according to the present disclosure is broadly applicable to a search for a person, an animal, etc., that carries the transmitter 50, or a search for an object having the transmitter 50 provided thereon.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-14. (canceled)

15. A search system that detects with at least one vehicle a wireless signal that is output from a transmitter and searches for the transmitter, the search system comprising:
the at least one vehicle including:
an antenna device to receive the wireless signal;
a measuring device to measure a direction of arrival of the wireless signal received by the antenna device;
a calculation circuit to estimate a position of the transmitter from the direction of arrival of the wireless signal as measured by the measuring device; and
a localization device to output position information by estimating a position of the at least one vehicle; wherein
the localization device outputs the position information of the at least one vehicle at least when the calculation circuit has estimated the position of the transmitter.

16. A search system that detects with at least one vehicle a wireless signal that is output from a transmitter and searches for the transmitter, the search system comprising:
the at least one vehicle;
the transmitter; and
a processor; wherein
the at least one vehicle includes:
an antenna device to receive the wireless signal;
a localization device to output position information by estimating a position of the at least one vehicle; and
a communication circuit to transmit a processed signal obtained from the wireless signal that is received by the antenna device and to transmit the position information;
the processor includes:
a communication circuit to receive the processed signal and the position information; and
a calculation circuit to measure a direction of arrival of the wireless signal based on the processed signal, and further estimate a position of the transmitter from the direction of arrival of the wireless signal and the position information.

17. The search system of claim 15, wherein the transmitter includes:
a primary battery;
an IC circuit to operate on the primary battery to generate the wireless signal; and
an antenna to output the wireless signal.

18. The search system of claim 15, wherein
the primary battery is a magnesium-air battery that begins power generation as a liquid is injected therein; and
the transmitter begins power generation as the liquid is automatically or manually injected into the primary battery when in need of a search, and begins to output the wireless signal.

19. The search system of claim 15, wherein the at least one vehicle further includes a plurality of rotors and a plurality of motors or engines to rotate the plurality of rotors, and flies in the air.

20. The search system of claim 19, wherein the at least one vehicle further includes an autonomous flight controller to control rotation of the plurality of motors or engines based on the position information as measured by the localization device.

21. The search system of claim 20, wherein
when the antenna device of the at least one vehicle has received the wireless signal,
the autonomous flight controller causes the at least one vehicle to stop or move within a space in which the wireless signal was received, and the antenna device continuously receives the wireless signal; and
the calculation circuit continuously estimates the position of the transmitter.

22. The search system of claim 21, wherein
the at least one vehicle includes a plurality of vehicles including a first vehicle and a second vehicle; and
the first vehicle and the second vehicle fly with a predetermined interval therebetween.

23. The search system of claim 21, wherein
the at least one vehicle includes a plurality of vehicles including a first vehicle and a second vehicle; and
when the antenna device of the first vehicle has received the wireless signal, the second vehicle acquires the position information of the first vehicle and moves toward the position of the first vehicle.

24. The search system of claim 19, wherein the vehicle flies based on an external instruction to fly.

25. The search system of claim 15, further comprising:
an output device to output a human visual, aural, and/or tactile stimulation based on a received signal to indicate that a search-requiring situation exists;
a communication circuit to receive the position information of the at least one vehicle; and
a calculation circuit to, in response to receiving the position information, generate a signal to cause the output device to operate and transmitting the signal to the output device.

26. The search system of claim 16, wherein
the processor further includes an output device to output a human visual, aural, and/or tactile stimulation based on a received signal to indicate that a search-requiring situation exists;
the communication circuit receives the position information of the at least one vehicle; and
in response to receiving the position information, the calculation circuit generates a signal to cause the output device to operate and transmit the signal to the output device.

27. A transmitter to be used in the search system of claim 15, comprising:
a primary battery;
an IC circuit to operate on the primary battery to generate the wireless signal; and
an antenna to output the wireless signal.

28. The transmitter of claim 27, wherein
the primary battery is a magnesium-air battery that begins power generation as a liquid is injected therein; and
the transmitter begins power generation as the liquid is automatically or manually injected into the primary battery when in need of a search, and begins to output the wireless signal.

29. The search system of claim 16, wherein the transmitter includes:
a primary battery;
an IC circuit to operate on the primary battery to generate the wireless signal; and
an antenna element to output the wireless signal.

30. The search system of claim 16, wherein,
the primary battery is a magnesium-air battery that begins power generation as a liquid is injected therein; and
the transmitter begins power generation as the liquid is automatically or manually injected into the primary battery when in need of a search, and begins to output the wireless signal.

31. The search system of claim 16, wherein the vehicle further includes a plurality of rotors and a plurality of motors or engines to rotate the plurality of rotors, and flies in the air.

32. The search system of claim 31, wherein the vehicle further includes an autonomous flight controller to control rotation of the plurality of motors or engines based on the position information as measured by the localization device.

33. The search system of claim 32, wherein
when the antenna device of the vehicle has received the wireless signal,
the autonomous flight controller causes the vehicle to stop or move within a space in which the wireless signal was received, and the antenna device continuously receives the wireless signal, and
the calculation circuit continuously estimates the position of the transmitter.

34. The search system of claim 33, wherein
the at least one vehicle includes a plurality of vehicles including a first vehicle and a second vehicle; and
the first vehicle and the second vehicle fly with a predetermined interval therebetween.
